(19) United States
(12) Patent Application Publication
(10) Pub. No.: US 2016/0100470 A1
(43) Pub. Date: Apr. 7, 2016

(54) METHOD AND TECHNOLOGY FOR CREATING/INSTALLING DISPLAY DEVICES

(71) Applicant: Google Inc., (US)

(72) Inventor: David Li-Kuang Chen, Mountain View, CA (US)

(73) Assignee: Google Inc., Mountain View, CA (US)

(21) Appl. No.: 13/863,298

(22) Filed: Apr. 15, 2013

(51) Int. Cl. H05B 33/10

(52) U.S. Cl. CPC H05B 33/10

(57) ABSTRACT

Embodiments of the disclosure describe apparatuses, systems and methods for display device creation and installation. Said embodiments execute operations for receiving data identifying dimensions of a target surface, said target surface being a surface for creating and installing a display device and for a user to view the display device. In response to receiving data identifying dimensions of the target surface, a three dimensional (3D) fabrication process is executed to form at least some components of the display device. When the pixel area of the display device is formed, the pixel control circuitry of the display device is communicatively coupled to a display driver component to install the display device onto the target surface; said display driver component receives image data and drives the pixel control circuitry based on the received image data.

### TECHNICAL FIELD

Embodiments of the disclosure relate to the field of display devices, and more particularly, to apparatuses, systems and processes for creating and installing display devices.

### BACKGROUND

Consumer demand for large display devices (e.g., televisions) continues to increase, while the expected sale price of these devices continues to decrease. The manufacturing and installation expenses for these devices are controlling factors for their overall costs. What is needed is a method and technology for creating and installing display devices that reduces the costs of manufacture and installation, while providing the ability to create and install display devices for a wide range of dimensions and shapes.

### BRIEF DESCRIPTION OF THE DRAWINGS

The present disclosure will be understood more fully from the detailed description given below and from the accompanying drawings of various embodiments of the disclosure, which, however, should not be taken to limit the invention to the specific embodiments, but are for explanation and understanding only.

FIG. 1 is a flow diagram of a process for creating and installing a display device according to an embodiment of the disclosure.

FIG. 2 is an illustration of a display device being created/installed according to an embodiment of the disclosure.

FIG. 3 is a cross section of OLED layers formed according to an embodiment of the disclosure.

FIG. 4 is an illustration of display device being created/installed according to an embodiment of the disclosure.

FIG. 5 is an illustration of a computing device to utilize an embodiment of the disclosure.

### DETAILED DESCRIPTION

Embodiments of apparatuses, systems and methods for creating display devices are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

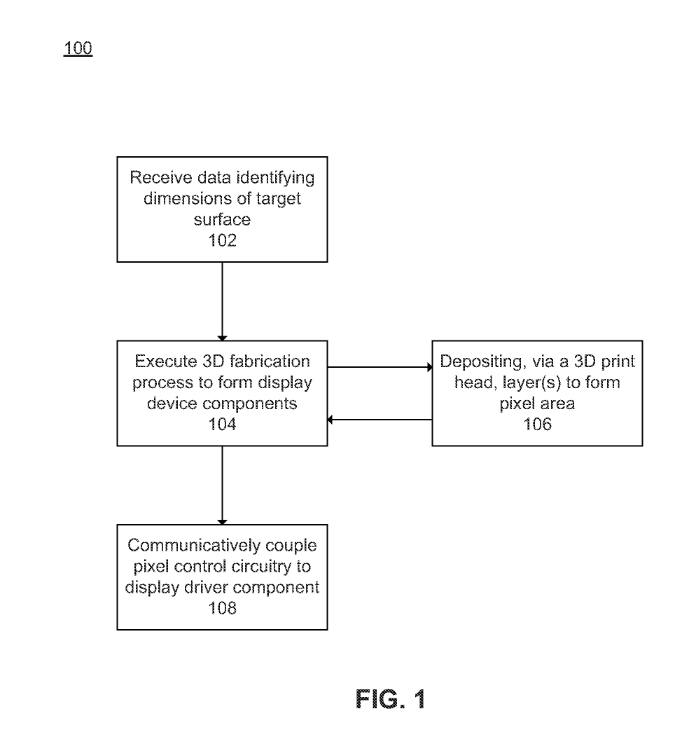

FIG. 1 is a flow diagram of a process for creating and installing a display device according to an embodiment of the disclosure. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the disclosure; thus, not all actions are required in every implementation. Other process flows are possible.

Process 100 includes operations for receiving data identifying dimensions of a target surface, 102, wherein the target surface is a surface to create and install a display device and for a user to view the (created and installed) display device. This received data may be, for example, image data of the target surface or data input by a user to specify the dimensions of the target surface. As described below, said target surface is a surface wherein embodiments of the disclosure create and install a display device.

In response to receiving data identifying dimensions of a target surface, a three dimensional (3D) fabrication process is executed to form at least some components of the display device, 104. For example, a pixel area of the display device may be created according to the dimensions of the target surface using 3D object fabrication techniques.

3D object fabrication techniques, alternatively referred to as 3D printing, stereolithography, or solid freeform fabrication (SFF), create an object by building it layer-by-layer or point-by-point, and can be executed with or without a pre-formed mold. 3D object fabrication techniques may comprise an additive process in which an object is formed by depositing layers or points (e.g., droplets) of one or more base materials.

In this embodiment, said 3D fabrication process includes operations for depositing, via a 3D print head coupled to an actuating member, one or more layers of material used to form pixels of a display device's pixel area on the target surface, 106. In some embodiments, said layers of material are deposited on pixel control circuitry to control illumination of the pixels; in other embodiments, said 3D fabrication process includes operations for forming said pixel control circuitry (e.g., depositing, via the 3D print head, one or more layers of conductive material for forming the pixel control circuitry).

Embodiments of the disclosure may use liquid-ejection processes, such as binder-jetting processes and bulk jetting processes. Binder jetting processes create objects by ejecting a binder onto a layer of powdered build material. Each powder layer may be dispensed or spread as a dry powder or a slurry. When the binder is selectively ejected into the powder layer, the powder is bound into a cross section or layer of the object being formed—i.e., the pixel area of said display device. Bulk-jetting processes generate objects by ejecting a solidifiable build material and a corresponding solidifiable support material. Said support material may be dispensed to enable overhangs in the object and can be of the same or different material from the object.

Other additive manufacturing techniques that may be used to create said pixel area and/or said pixel control circuitry include: selective laser sintering, direct metal laser sintering, electron beam melting, electron beam freeform fabrication, or any other functionally equivalent three-dimensional printing process (such as processes executed via thermal phase change inkjet-style printing systems or photopolymer phase change inkjet-style printing systems).

Embodiments of the disclosure may be used to build and install any display device component that is creatable via a 3D fabrication process. Organic Light Emitting Displays (OLEDs) are discussed below for exemplary purposes; OLEDs comprise several layers of material, so embodiments of the disclosure may deposit one or more layers of material used to form the pixels of the pixel area—specifically for an OLED, an anode layer, a conductive layer, an emissive layer (which comprises, for example, Red-Green-Blue (RGB) pixels) and a cathode layer. However other display devices may be created, such as a Liquid Crystal Display (LCD), a Light Emitting Diode (LED) backlit LCD display, or display devices wherein the pixels of said pixel area comprise layers of phosphor material for forming RGB phosphors, and the pixel control circuitry comprises circuitry to activate each phosphor. Furthermore, said display device may comprise a 3D television (3DTV) device—i.e., a display device configured to convey depth perception via processes such as stereoscopic display, multi-view display, two-dimensional (2D) plus-depth, or any other functionally equivalent process.

In the above described processes, fabrication is typically performed layer-by-layer, with each layer representing another cross section of the resultant pixel area. Adjacent layers are adhered to one another in a predetermined pattern to build up the desired object. It is to be understood that the above description is intended to be illustrative, and not restrictive.

In other embodiments, a combination of additive and subtractive processes may be used to create said pixel area and/or said pixel control circuitry. Said subtractive processes may be any process for removing materials, such as dissolving, melting, milling, sanding, polishing or mechanically breaking materials, or simply moving material (such as loose, unfused powder) away. For example, 3D fabrication processes may initially be additive (with material being deposited to make both the parts and support materials), and then subtractive (e.g. support materials being removed).

When the pixel area of the display device is formed, the pixel control circuitry of the display device is communicatively coupled to a display driver component, 108, which may be disposed, for example, behind or next to said “printed” pixel control circuitry. Said display driver component receives image data, drives the pixel control circuitry based on the received image data, and may also provide power to the display device. Thus, the display device is both created and installed on the target surface.

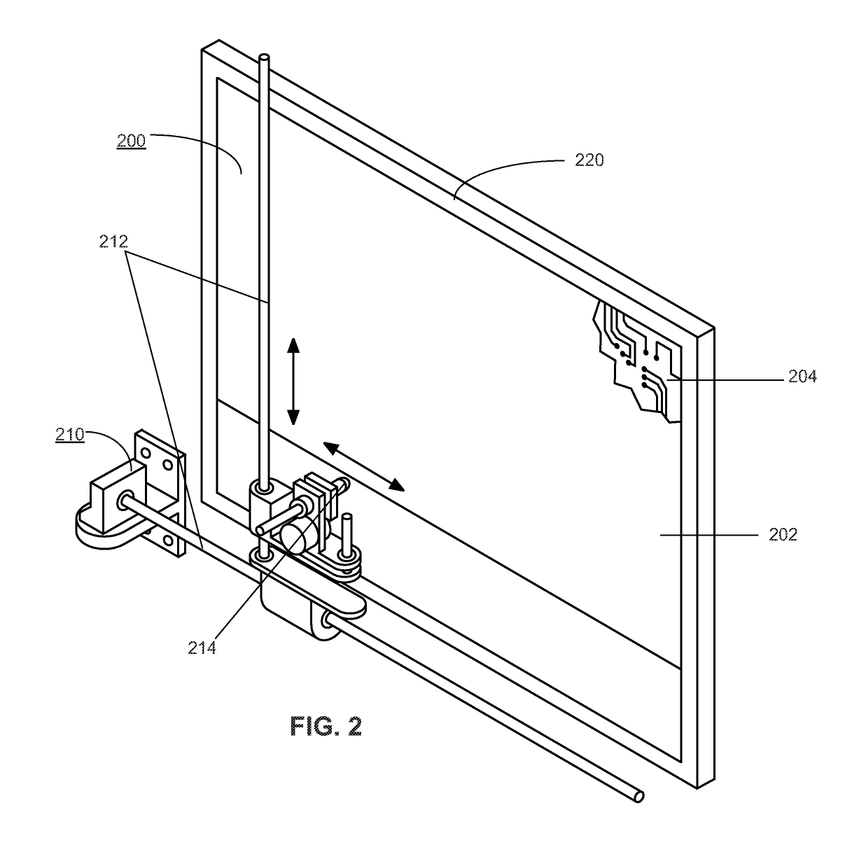

FIG. 2 is an illustration of a display device being created/installed according to an embodiment of the disclosure. In this embodiment, display device 200 is being generated by 3D printer 210 depositing material onto at least a portion of wall 220 (e.g., an interior or exterior wall of building). Thus, (at least a portion of) wall 220 is the target surface for creating and installing display device 200, and the target surface for a user to view the display device. As shown in this embodiment, 3D printer 210 includes a plurality of removable wall-mounted tracks 212 mounted onto wall 220 (i.e., disposed in front of the target surface); 3D print head 214 is shown to be included in a motorized housing to move the print head vertically and horizontally across the target surface via the wall-mounted tracks.

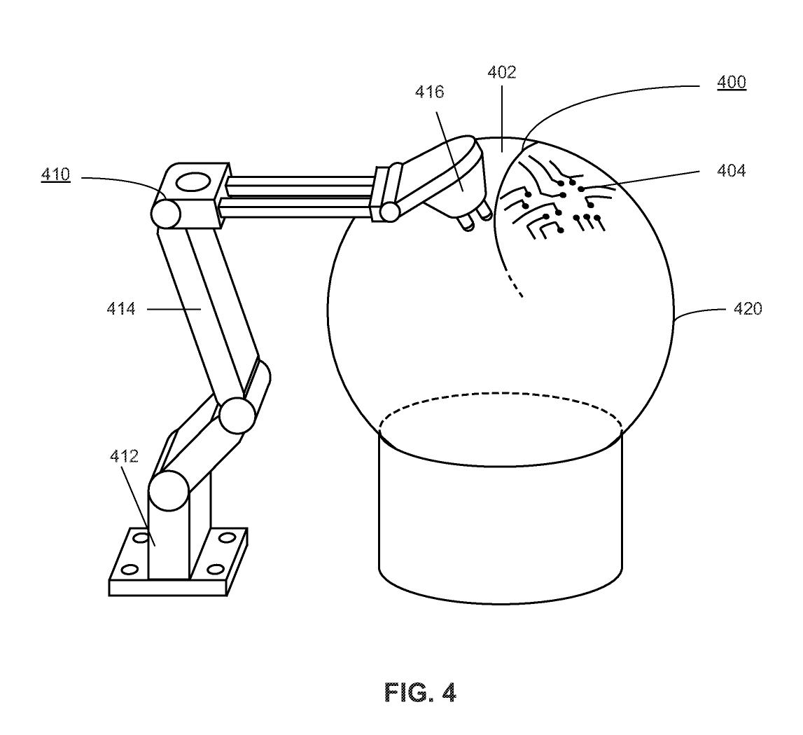

Thus, display device 200 is created according to the dimensions of wall 220. 3D printer 210 may be controlled to create the display device on the entire surface of wall 220, or a portion of the wall. A user may purchase or rent the components described above to create an install a display device on a user-selected target surface. Furthermore, while the target surface in this is example is single flat surface, embodiments of the disclosure may also create and install display devices on a plurality of adjacent surfaces, on a protruding or uneven surface (e.g., a spherical surface as illustrated in FIG. 4 and described below), or any otherwise non-planar surface.

In this embodiment, display device 200 is illustrated as an OLED device, including pixel area 202 formed on pixel control circuitry 204. 3D printer 210 creates the pixel area by forming the layers of the OLED device—i.e., the anode layer, the conductive layer, the emissive layer and the cathode layer.

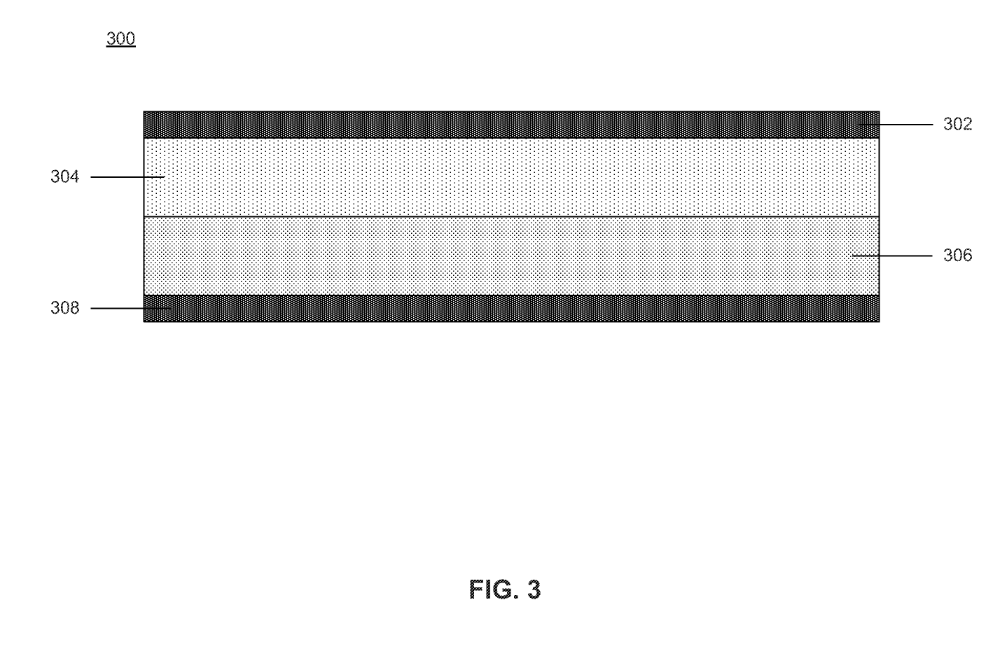

FIG. 3 is a cross section of OLED layers formed according to an embodiment of the disclosure. In this embodiment, OLED display device 300 is shown to comprise cathode layer 302 and corresponding anode layer 308, emissive (i.e., electroluminescent) layer 304 and conductive layer 306 disposed between said cathode and anode layers. These layers are formed via a 3D fabrication process, as described above. Referring back to FIG. 2, pixel control circuitry 204 provides electric current to the anode layer and the cathode layer, as described below.

When a voltage bias is applied to these layers, electrons are injected by cathode layer 302 into emissive layer 304, while holes are injected into the emissive layer from anode layer 308 via conductive layer 306; light emission may occur as holes combine with electrons within emissive layer 304.

Emissive layer 304 may comprise any layer that, when in operation, contains a significant concentration of both electrons and holes and provides areas for light emission. Cathode layer 302, anode layer 308 and conductive layer 306 may comprise conductive materials, including (but are not limited to) metals, which can inject holes/electrons into the layers of OLED display device 300.

In other embodiments, other layers may be present in OLED display device 300—e.g., a hole injection layer, a hole transporting layer, an electron injection layer, an electron transport layer, hole transporting emission (emitting) layers, electron transporting emission (emitting) layers, etc. Furthermore, in some embodiments, OLED display device 300 may comprise passive matrix displays having orthogonal arrays of anodes and cathodes to form pixels (i.e., wherein the OLED display comprises a passive matrix OLED display having a matrix of pixels, and depositing the anode layer and the cathode layer comprises depositing strips of anode layers and cathode layers perpendicularly to form the matrix of pixels at intersecting points of the strips of anode layers and the strips of cathode layers), or active-matrix displays (i.e., wherein the OLED display comprises an active matrix OLED display having a matrix of pixels, and the 3D printing process further comprises depositing material, disposed above the cathode layer, to form a thin film transistor (TFT) array to form the matrix of the pixels). Furthermore, device 300 may comprise a top or bottom emitting OLED device.

FIG. 4 is an illustration of display device being created/installed according to an embodiment of the disclosure. In this embodiment, display device 400 is being generated by 3D printer 410 onto a non-planar surface—in this example, spherical surface 420. Thus, spherical surface 420 is the target surface for creating and installing display device 400, and the target surface for a user to view the display device. As shown in this embodiment, 3D printer 410 is a standalone printer, including stand 412, actuating arm 414 and 3D print head 416; said actuating arm is to move said 3D print head based on the dimensions of spherical target surface 420 when depositing the one or more layers of material used to form the pixels of the pixel area.

In this embodiment, 3D printer 410 utilizes an image sensor or image scanner (not shown) to capture image data identifying the dimensions of spherical surface 420. In other embodiments, previously captured image data or user input data may be used to determine the dimensions of said spherical surface. Device 400 is shown to include pixel area 402 formed on pixel control circuitry 404. Pixel control circuitry 404 may also be formed by 3D printer 410, or may be pre-fabricated for the user to place on surface 420 prior to executing the 3D printing process.

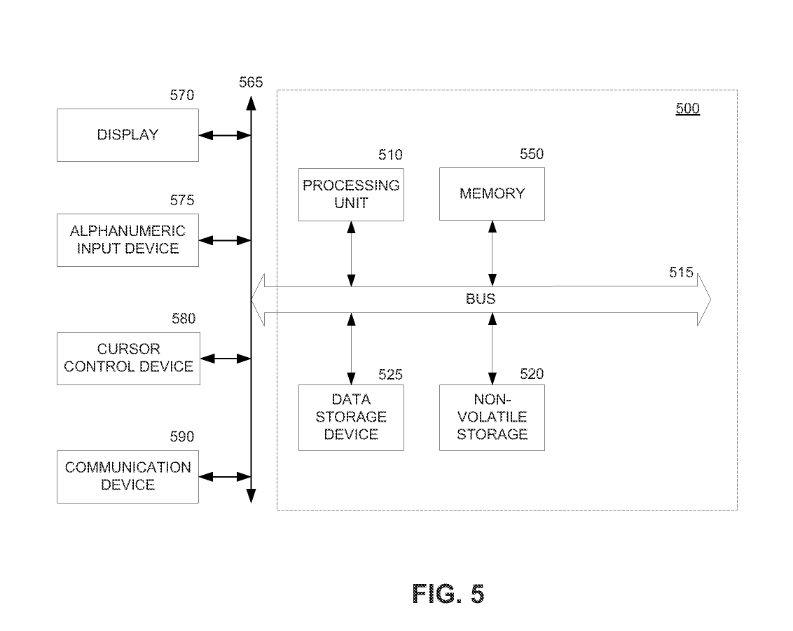

FIG. 5 is an illustration of a computing device to utilize an embodiment of the disclosure. Platform 500 may be used to control/execute the 3D printing process described above. Platform 500 may also be used to provide power, computing ability (e.g., decoding and converting content) and connectivity (e.g., network connectivity) to a created and installed display device, as described above. For example, platform 500 may comprise the above described display driver component communicatively coupled to the above described pixel control circuitry. Platform 500 may be used to decode/convert content into video signal formats such as high definition multimedia interface (HDMI), component, composite digital visual interface (DVI), video graphics adapter (VGA), Syndicat des Constructeurs d′Appareils Radiorecepteurs et Televiseursor (SCART), or other video signal formats. Furthermore, in some embodiments, portions of platform 500 described below may be formed by the 3D printing processes described above.

Platform 500 as illustrated includes bus or other internal communication means 515 for communicating information, and processor 510 coupled to bus 515 for processing information. The platform further comprises random access memory (RAM) or other volatile storage device 550 (alternatively referred to herein as main memory), coupled to bus 515 for storing information and instructions to be executed by processor 510. Main memory 550 also may be used for storing temporary variables or other intermediate information during execution of instructions by processor 510. Platform 500 also comprises read only memory (ROM) and/or static storage device 520 coupled to bus 515 for storing static information and instructions for processor 510, and data storage device 525 such as a magnetic disk, optical disk and its corresponding disk drive, or a portable storage device (e.g., a universal serial bus (USB) flash drive, a Secure Digital (SD) card). Data storage device 525 is coupled to bus 515 for storing information and instructions.

Platform 500 may further be coupled to display device 570, such as a cathode ray tube (CRT) or an LCD coupled to bus 515 through bus 565 for displaying information to a computer user. In embodiments where platform 500 provides computing ability and connectivity to a created and installed display device, display device 570 may comprise any of the created and display devices described above. Alphanumeric input device 575, including alphanumeric and other keys, may also be coupled to bus 515 through bus 565 (e.g., via infrared (IR) or radio frequency (RF) signals) for communicating information and command selections to processor 510. An additional user input device is cursor control device 580, such as a mouse, a trackball, stylus, or cursor direction keys coupled to bus 515 through bus 565 for communicating direction information and command selections to processor 510, and for controlling cursor movement on display device 570. In embodiments utilizing a touch-screen interface, it is understood that display 570, input device 575 and cursor control device 580 may all be integrated into a touch-screen unit.

Another device, which may optionally be coupled to platform 500, is a communication device 590 for accessing other nodes of a distributed system via a network. Communication device 590 may include any of a number of commercially available networking peripheral devices such as those used for coupling to an Ethernet, token ring, Internet, or wide area network. Communication device 590 may further be a null-modem connection, or any other mechanism that provides connectivity between computer system 500 and the outside world. Note that any or all of the components of this system illustrated in FIG. 5 and associated hardware may be used in various embodiments of the disclosure.

It will be appreciated by those of ordinary skill in the art that any configuration of the system illustrated in FIG. 5 may be used for various purposes according to the particular implementation. The control logic or software implementing embodiments of the disclosure can be stored in main memory 550, mass storage device 525, or other storage medium locally or remotely accessible to processor 510.

It will be apparent to those of ordinary skill in the art that any system, method, and process to capture media data as described herein can be implemented as software stored in main memory 550 or read only memory 520 and executed by processor 510. This control logic or software may also be resident on an article of manufacture comprising a computer readable medium having computer readable program code embodied therein and being readable the mass storage device 525 and for causing processor 510 to operate in accordance with the methods and teachings herein.

Embodiments of the disclosure may also be embodied in a handheld or portable device containing a subset of the computer hardware components described above. For example, the handheld device may be configured to contain only the bus 515, the processor 510, and memory 550 and/or 525. The handheld device may also be configured to include a set of buttons or input signaling components with which a user may select from a set of available options. The handheld device may also be configured to include an output apparatus such as a LCD or display element matrix for displaying information to a user of the handheld device. Conventional methods may be used to implement such a handheld device. The implementation of the disclosure for such a device would be apparent to one of ordinary skill in the art given the disclosure as provided herein.

Embodiments of the disclosure may also be embodied in a special purpose appliance including a subset of the computer hardware components described above. For example, the appliance may include processor 510, data storage device 525, bus 515, and memory 550, and only rudimentary communications mechanisms, such as a small touch-screen that permits the user to communicate in a basic manner with the device. In general, the more special-purpose the device is, the fewer of the elements need be present for the device to function.

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent series of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion above, it is appreciated that throughout the description, discussions utilizing terms such as “capturing,” “transmitting,” “receiving,” “parsing,” “forming,” “monitoring,” “initiating,” “performing,” “adding,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

Some portions of the detailed description above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “capturing”, “determining”, “analyzing”, “driving”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The algorithms and displays presented above are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout the above specification are not necessarily all referring to the same embodiment. Furthermore, the particular features, structures, or characteristics may be combined in any suitable manner in one or more embodiments.

The present description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the various embodiments with various modifications as may be suited to the particular use contemplated.

1. A method comprising:
receiving data identifying dimensions of a target surface, wherein the target surface comprises a surface on a wall for creating and installing a display device directly onto the wall;
executing a three dimensional (3D) printing process to at least partially create the display device by forming a pixel area of the display device over a pre-fabricated layer including pixel control circuitry disposed on the target surface, the 3D printing process comprising:
depositing, via a 3D print head coupled to an actuating member, one or more layers of material used to form pixels of the pixel area onto the pixel control circuitry disposed on the target surface, the pixel control circuitry to control illumination of the pixels; and
communicatively coupling the pixel control circuitry of the display device to a display driver component to install the display device on the target surface, the display driver component to receive image data and drive the pixel control circuitry based on the received image data.

2. The method of claim 1, wherein the target surface further comprises a portion of an interior wall of a building.

3. The method of claim 2, wherein the 3D print head is included in a 3D printer further comprising a plurality of removable tracks mounted onto the interior wall of the building, and the actuating member comprises a motorized housing including the 3D print head to move vertically and horizontally across the interior wall of the building via the plurality of removable tracks.

4. The method of claim 1, wherein the 3D print head is included in a 3D printer further comprising a stand, and the actuating member comprises an actuating arm including the 3D print head and coupled to the stand, the actuating arm to move the 3D print head based on the dimensions of the target surface when depositing the one or more layers of material used to form the pixels of the pixel area.

5. The method of claim 1, wherein the 3D printing process further comprises:
depositing, via the 3D print head, one or more layers of conductive material onto the target surface for forming the pixel control circuitry.

6. The method of claim 1, wherein the display comprises an OLED display, and the one or more layers of material used to form the pixels of the pixel area comprises:
an anode layer;
a conductive layer;
an emissive layer; and
a cathode layer;
wherein the pixel control circuitry to provide electric current to the anode layer and the cathode layer.

7. The method of claim 6, wherein the OLED display comprises a passive matrix OLED display having a matrix of pixels, and depositing the anode layer and the cathode layer comprises:
depositing strips of anode layers and cathode layers perpendicularly to form the matrix of pixels at intersecting points of the strips of anode layers and the strips of cathode layers.

8. The method of claim 6, wherein the OLED display comprises an active matrix OLED display having a matrix of pixels, and the 3D printing process further comprises:
depositing material, disposed above the cathode layer, to form a thin film transistor (TFT) array to form the matrix of the pixels.

9. The method of claim 1, wherein the or more layers of material used to form the pixels of the pixel area comprise phosphor material for forming Red-Green-Blue (RGB) phosphors, and the pixel control circuitry comprises circuitry to activate each phosphor.

10. The method of claim 1, wherein the received data identifying the dimensions of the target surface comprises image data of the target surface captured via an image sensor.

11. The method of claim 1, wherein the target surface comprises a planar surface.

12. A system comprising:
a three dimensional (3D) fabrication device including a 3D print head;
an actuating member coupled to 3D print head to move the 3D print head over a target surface, wherein the target surface comprises a surface for creating a display device; and
a 3D fabrication device controller to:
receive data identifying dimensions of the target surface; and
control the 3D fabrication device to execute a 3D fabrication process to at least partially create the display device by forming a pixel area of the display device based on the dimensions of the target surface, wherein the 3D fabrication process includes operations to deposit, via the 3D print head, one or more layers of material used to form pixels of the pixel area onto pixel control circuitry disposed on the target surface.

13. The system of claim 12, wherein the target surface further comprises an interior wall of a building.

14. The system of claim 13, wherein the 3D fabrication device further comprises a plurality of removable tracks mounted onto the interior wall of the building, and the actuating member comprises a motorized housing including the 3D print head to move vertically and horizontally across the interior wall of the building via the plurality of removable tracks.

15. The system of claim 12, wherein the 3D fabrication device further comprises a stand, and the actuating member comprises an actuating arm including the 3D print head and coupled to the stand, the actuating arm to move the 3D print head based on the dimensions of the target surface to deposit the one or more layers of material used to form the pixels of the pixel area.

16. The system of claim 12, wherein the 3D fabrication process further includes operations to deposit, via the 3D print head, one or more layers of conductive material onto the target surface for forming the pixel control circuitry.

17. The system of claim 12, wherein the display comprises an OLED display, and the one or more layers of material used to form the pixels of the pixel area comprises:
an anode layer;
a conductive layer;
an emissive layer; and
a cathode layer;
wherein the pixel control circuitry is to provide electric current to the anode layer and the cathode layer.

18. The system of claim 17, wherein the OLED display comprises a passive matrix OLED display having a matrix of pixels, and operations to deposit the anode layer and the cathode layer comprises operations to deposit strips of anode layers and cathode layers perpendicularly to form the matrix of pixels at intersecting points of the strips of anode layers and the strips of cathode layers.

19. The system of claim 17, wherein the OLED display comprises an active matrix OLED display having a matrix of pixels, and the 3D fabrication process further includes operations to deposit material, disposed above the cathode layer, to form a thin film transistor (TFT) array to form the matrix of the pixels.

20. The system of claim 12, wherein the or more layers of material used to form the pixels of the pixel area comprise phosphor material for forming Red-Green-Blue (RGB) phosphors, and the pixel control circuitry comprises circuitry to activate each phosphor.

21. The system of claim 12, further comprising:
an image sensor to capture image data identifying the dimensions of the target surface.

22. The system of claim 12, further comprising:
a user interface to receive user input data identifying the dimensions of the target surface.

23. The method of claim 1, wherein the target surface comprises a non-planar surface.
